(19) United States
(12) Patent Application Publication
(10) Pub. No.: US 2010/0196855 A1
(43) Pub. Date: Aug. 5, 2010

(54) IMPRESSION POST FOR A DENTAL IMPLANT

(75) Inventors: Daniele Müller, Binningen (CH); Hans Schürch, Titterten (CH); Fabian Schwieder, Basel (CH); Frank Kenk, Weil (DE); Holger Kast, Lorrach (DE)

Correspondence Address: RISSMAN HENDRICKS & OLIVERIO, LLP, 100 Cambridge Street, Suite 2101, BOSTON, MA, 02114, US

(73) Assignee: Straumann Holding AG, Basel (CH)

(21) Appl. No.: 12/695,280

(22) Filed: Jan. 28, 2010

(30) Foreign Application Priority Data
Jan. 31, 2009 (EP) EP 09 001 362.4

(51) Int. Cl. A61C 13/10; A61C 9/00

(52) U.S. Cl. 433/193; 433/214

(57) ABSTRACT

Impression post for a dental implant, having a sleeve-shaped impression cap (4) with a coupling section (16) configured to be connected to the dental implant (20), and a substantially cylindrical recess (6) extending in the longitudinal direction of the impression cap (4) and an attachment element (8) engaging through the recess (6) for attaching the impression cap (4) on the dental implant (20). The impression cap (4) has an inner sleeve (10) and an outer sleeve (12) radially surrounding said inner sleeve on the outside, which outer sleeve is detachably connected to the inner sleeve (10), and the coupling section (16) is at least partly an element of the inner sleeve (10).

### FIELD OF THE INVENTION

The present invention relates to an impression post for a dental implant, a method for taking a dental implant impression using this impression post and to the use of the impression post for taking an “open tray” impression.

### BACKGROUND

Impression posts (also known as “forming posts”) are used in dentistry for transferring the position and alignment of a dental implant inserted into the jaw bone, in respect of its surroundings, to a so-called master model, on the basis of which the dental technician produces the prosthetic element to be applied to the dental implant.

To this end, the impression post usually has an impression cap and a suitable attachment element connected thereto for attaching the impression cap to the dental implant. With the aid of an impression spoon, the space surrounding the impression post and the adjacent tissue structures in the oral region of the patient is filled by an initially plastically deformable, curable impression compound. The impression compound removed from the oral region of the patient after curing forms a negative model which is used as an original for the master model.

Impression posts or corresponding impression methods are described in the prior art, for example in Schroeder, A. et al., “Orale Implantologie” [Oral implantology], 2nd edition, Georg Thieme Verlag, Stuttgart, 1994, p. 202 ff. Furthermore, reference is made to, for example, EP-A-1274365, EP-A-1274366, WO2007/093648, U.S. Pat. No. 6,213,773, U.S. Pat. No. 6,379,148, U.S. Pat. No. 6,524,106, U.S. Pat. No. 6,508,650, EP-A-0747017 and U.S. Pat. No. 6,045,361, which also relate to impression posts.

When taking an impression, a distinction is made between taking “open tray” impressions and “closed tray” impressions. Here, in contrast to taking a “closed tray” impression, taking an “open tray” impression involves detaching the attachment element which is used to attach the impression cap to the dental implant before removing the impression compound from the oral region of the patient. Since the attachment element is generally present in the form of a screw, the corresponding region of the impression spoon has a recess through which the screw can be gripped, for example by using a screwdriver. “Open tray” and “closed tray” impression methods are known to a person skilled in the art and are described in, for example, U.S. Pat. No. 7,066,736, the subject matter of which is hereby incorporated by reference in its entirety.

When the impression spoon is removed, the impression cap remains in the impression compound when an “open tray” impression is being taken. Subsequently, a manipulation implant can be inserted into the impression cap in an accurately fitting fashion, which implant is in turn embedded in hard plaster when the master model is produced. Hence, in the master model, the manipulation implant precisely indicates the position of the dental implant in the jaw bone of the patient. Impression posts which can be used for taking an “open tray” impression are described in, for example, U.S. Pat. No. 5,213,502 and US-A-2006/0121416.

Conventional impression caps often have a polygonal base or a polygonal opening in their apical end region, i.e. in the end region facing the dental implant, which base or opening is designed for an accurate fit in respect of the base or the opening in the coronal end region of the dental implant and is intended to ensure anti-twist protection between the impression cap and the dental implant. This can ensure that the impression post does not twist, in particular while the impression is being taken, and, hence, that the rotational position of the dental implant can be precisely transferred to the manipulation implant. Moreover, if the dental implant has a coronal opening, this prevents ingress of the impression compounds into this opening.

However, the static friction between the impression cap and the dental implant resulting from this anti-twist device is also relatively large in the axial direction. This is of consequence, particularly when simultaneously taking the impression of a number of impression posts which are arranged obliquely with respect to one another. In such cases, the impression compound can only be removed by utilizing the elasticity of the impression compound and this carries the risk of a plastic deformation of the impression compound if there is a relatively large deflection of the impression post from the position it assumed while the impression was being taken, possibly resulting in the position transferred to the manipulation implant being falsified.

By way of example, EP-A-1274365 addresses this problem; it describes a post-shaped element comprising a lower part, which can be fixed in a holding recess of the implant, and an upper part, which can be inserted into or placed onto said lower part, wherein the upper part can be removed linearly from the lower part in different directions, starting from the connection position of the post-shaped element. A disadvantage of the post-shaped element as per EP-A-1274365 lies in the fact that it is only suitable for implants designed in a very specific fashion. Furthermore, a disadvantage of the post-shaped element is that it comprises an adhesive ring for the attachment to the implant and this can lead to problems in respect of the tolerance of the patient. Moreover, reference is made to the disadvantages of the “closed tray” method described in U.S. Pat. No. 7,066,736, column 2, lines 20 to 24.

### SUMMARY OF THE INVENTION

According to the present invention, an impression post is provided which can be used in a number of ways and can be used for taking an “open tray” impression. The impression post ensures a very precise transfer of the position of the dental implants, even in the case where impressions of a number of dental implants which are arranged obliquely in respect of one another are taken simultaneously.

In accordance with one embodiment of the present invention, an impression cap of an impression post has an inner sleeve and an outer sleeve radially surrounding said inner sleeve on the outside, which outer sleeve is detachably connected to the inner sleeve. Consequently, the inner sleeve is arranged between an attachment element and the outer sleeve, the latter forming a barrier when the impression is being taken, with the barrier preventing the inner sleeve from contacting the impression compound.

According to one embodiment, a coupling section, that is to say a region which is configured to be connected to the dental implant, is at least partly an element of the inner sleeve.

When the impression is being taken, this two-part design of the impression cap allows for steps in which the connection between the impression cap and the dental implant is lifted and the impression compound is removed from the dental implant to be effected in two mutually separate steps.

In the first of the two steps, the connection between the impression cap and the dental implant is at least partly lifted at the same time as, or directly after, the attachment element is detached.

By way of example, in the case where a coupling section of the impression cap is anchored in a corresponding opening in the dental implant, this can be effected in a simple fashion by the inner sleeve, or the coupling section thereof, being pulled out of the opening. During this displacement of the inner sleeve in the longitudinal direction of the dental implant, or of the impression cap anchored therein, the outer sleeve is kept in the impression compound surrounding it in a stationary fashion. Since, in this step, the inner sleeve is pulled out in the longitudinal direction, the resulting static friction between the inner sleeve and dental implant can be kept to a minimum.

In a second of the two steps, the impression compound with the outer sleeve embedded therein can be removed, the impression compound then only having a very small contact surface—if any—with the dental implant and hence having very little static friction.

As described above, that region of the impression cap which is connected to the dental implant in the assembled state is referred to as the coupling section. By way of example, the coupling section can be designed such that it is anchored in a corresponding opening of the dental implant. Alternatively, the coupling implant can be designed to be placed onto the base of, for example, a two-part dental implant. In general, the dental implant and impression post are arranged coaxially with respect to one another in the assembled state and this affords the possibility of a transfer of the axial alignment of the dental implant onto the master model which is as reliable as possible.

In one embodiment, the inner sleeve and/or the outer sleeve has a stop surface in the coupling section on the dental implant side, which stop surface, in the assembled state, is configured to lie on a corresponding counter stop surface of the dental implant, as a result of which precise transfer of the “depth position” of the dental implant in the surrounding tissue can be ensured.

According to one embodiment the inner sleeve and the outer sleeve are detachably connected to one another, with the outer surface of the inner sleeve generally at least partly resting against the inner surface of the outer sleeve. In one embodiment, the inner sleeve and outer sleeve can only be displaced in the longitudinal direction with respect to one another.

According to a preferred embodiment, the coupling section of the impression cap has a dental implant anti-twist device for anti-twist protection between the impression cap and the dental implant. This affords the possibility of precisely transferring not only the depth position and the axial alignment of the dental implant in respect of the surrounding tissue to the master model, but also of precisely transferring the rotational position of said implant.

Here, the dental implant anti-twist device is preferably completely an element of the inner sleeve in the above-described second step for the purpose of minimizing the static friction. This can keep the contact surface between the outer sleeve embedded in the impression compound and the dental implant to a minimum—provided such a contact surface even exists.

Moreover, a transfer of the rotational position to the master model which is as precise as possible is ensured if the inner sleeve furthermore has an outer sleeve anti-twist device for anti-twist protection between the inner sleeve and the outer sleeve. This ensures that the information relating to the rotational position is not only transferred from the dental implant to the inner sleeve, but also from the inner sleeve to the outer sleeve remaining in the impression compound. This outer sleeve anti-twist device can be for example in the form of a groove running in the longitudinal direction, with a latching element, such as a rail or a lug, correspondingly arranged on the outer sleeve engaging into said groove.

In accordance with a further preferred embodiment, the inner sleeve and the outer sleeve are arranged in a predetermined position with respect to one another in the circumferential direction. With reference to the described outer sleeve anti-twist device, this can be for example accomplished by only a single groove and a single rail engaging therein. Consequently, the rotational position of the dental implant can unambiguously be assigned to the manipulation implant or be transferred to the master model by means of the outer sleeve remaining in the impression compound.

In a particularly simple and therefore preferred embodiment, the inner sleeve and the outer sleeve are arranged coaxially with respect to one another.

Furthermore, it is preferable for the outer sleeve to have a profile on its outer surface which ensures a deep interlocking connection between the impression cap and the curable impression compound. In particular, the profile can be in the form of projections which project from the outer surface of the impression cap in a substantially perpendicular fashion in respect of the longitudinal direction of said impression cap.

In accordance with a preferred embodiment and for the purpose of transferring the position of the dental implant to the master model in a fashion which is as precise as possible, the coupling section is shaped so as to be held in a correspondingly shaped opening of the dental implant in an accurately fitting fashion.

Since conventional dental implants, such as the Bone Level Implants by the Straumann company, Basel CH, usually have a cylindrical region with at least one stop surface in the coronal opening thereof configured to ensure anti-twist protection with a corresponding counter stop surface of a component part, in accordance with a preferred embodiment of the invention, the coupling section of the inner sleeve is designed in the shape of a corresponding cylinder with counter stop surfaces. For example, a polygonal cylinder is particularly preferred. Alternatively, a pyramid frustum shape can be used for engaging a corresponding design of the opening of the dental implant.

Moreover, the abovementioned conventional dental implants often have a conical end region. In order to ensure that the impression compound cannot ingress into the opening even when impressions of these dental implants are being taken, the outer sleeve has, in accordance with a preferred embodiment, the shape of a conical frustum in the coupling section, which conical frustum is configured to be held in an accurately fitting fashion by the correspondingly designed conical end region. Alternatively, depending on the design of the opening of the dental implant, the outer sleeve in the coupling section can be shaped like a circular cylinder.

Moreover, ingress of the impression compound into the opening of said dental implants can be prevented by, instead of the outer sleeve, the inner sleeve being designed in the shape of a circular cylinder or a conical frustum in its corresponding section.

According to one embodiment, the impression cap has a recess extending in the longitudinal direction thereof. It is generally of a substantially cylindrical design. An attachment element for attaching the impression cap to the dental implant engages through the recess.

In one embodiment, the attachment element is in the form of a screw. It has a male thread which corresponds to a female thread in the coronal opening of the dental implant.

In accordance with a further preferred embodiment, the attachment element has a catch element which is configured to interact with a corresponding catch counter element on the inner sleeve such that, when the attachment element is pulled out of the outer sleeve, the inner sleeve is carried along. This ensures that the attachment element and the inner sleeve can be pulled out in a single step, without there being the need for a possibly complicated pulling out of the inner sleeve in a separate step.

A catch element can for example be formed by the male thread section of the attachment element, while the catch counter element can for example be formed as a protrusion projecting into the recess through which the attachment element engages. The diameter of the recess in this region can be tapered by the protrusion such that it is less than the diameter of the male thread section.

Furthermore, it is preferable to be able to connect the attachment element to the inner sleeve in an interlocking fashion. An additional loss protection of the attachment element or the inner sleeve is ensured by this interlocking connection.

In accordance with a further preferred embodiment the attachment element comprises a head part with a stop surface in its occlusal end region, i.e. in its end region facing away from the dental implant in the assembled state, which stop surface is configured to interact with an end-face counter stop surface of the inner sleeve and the outer sleeve such that the inner sleeve and the outer sleeve can be connected to the dental implant in a displacement-protected fashion. This can ensure that both the inner sleeve and the outer sleeve are also retained in their positions in the longitudinal direction while the impression is being taken, which furthermore ensures a precise transfer of the position of the dental implant to the master model.

The mentioned impression posts are particularly suitable for the Bone Level Implants, as distributed by the Straumann company, Basel CH, which are well known to a person skilled in the art. As a result of using said Bone Level Implants, taking an impression often results in the problem of the attachment element not being long enough to project beyond the occlusal surface of the impression compound. In order to detach the attachment element from the dental implant, it is therefore often necessary to uncover the attachment element, for example by peeling off the impression compound to an appropriate depth in said region.

This problem is solved in accordance with another aspect of the invention, according to which the impression post additionally comprises an extension element arranged on the attachment element.

In one embodiment, the extension element is preferably present in the form of a hollow cylinder placed onto the attachment element. The hollow cylinder is placed onto the head part, with the inner diameter of the hollow cylinder basically corresponding to the outer diameter of the head part. While the impression is being taken, the hollow cylinder prevents the grip region of the attachment element, which is generally arranged on the head part, from being covered by the impression compound. Rather, the grip region remains accessible through the channel formed by the hollow cylinder for a tool such as a screwdriver for detaching the attachment element.

In one embodiment, the inner sleeve and the attachment element of the impression post are produced from metal, whereas the outer sleeve is produced from plastic. However, every other material suitable for the corresponding purpose can be used for each individual component.

As described above, the present invention permits performing that step in which the connection between the impression cap and the dental implant is lifted and the impression compound is removed from the dental implant, in two separate steps.

Consequently, the invention according to one embodiment also relates to a method for taking a dental implant impression using the impression post according to the invention, comprising the successive steps of
a) attaching the impression post to the dental implant by the attachment element,
b) taking an impression of the impression post and the tissue structures which surround it by using an impression compound,
c) detaching the attachment element and at least partly lifting the connection between the impression cap and the dental implant and
d) removing the impression compound together with the outer sleeve of the impression cap.

As mentioned above, one embodiment of the invention also relates to the use of the impression post for taking an “open tray” impression.

### BRIEF DESCRIPTION OF THE DRAWINGS

Various embodiments of the invention will be explained in more detail on the basis of the figures, in which

FIG. 1 is a side plan view of an impression post according to one embodiment of the invention, which is anchored in a schematically illustrated dental implant and on which an extension element is placed;

FIG. 2 is a longitudinal sectional view along the line II-II′ in FIG. 1, with the attachment element illustrated in a side view;

FIG. 3 is a cross sectional view of the embodiment illustrated in FIG. 1 along the section line III-III′;

FIG. 4 is a partial longitudinal sectional view of the attachment element illustrated in FIG. 2, half in a cross-sectional view and half in a side view;

FIG. 5 is a more detailed view of the coupling section of the impression cap of FIGS. 1-4; and

FIG. 6 is a block diagram of method steps for one embodiment of taking a dental implant impression using the impression post of FIGS. 1-4.

### DETAILED DESCRIPTION

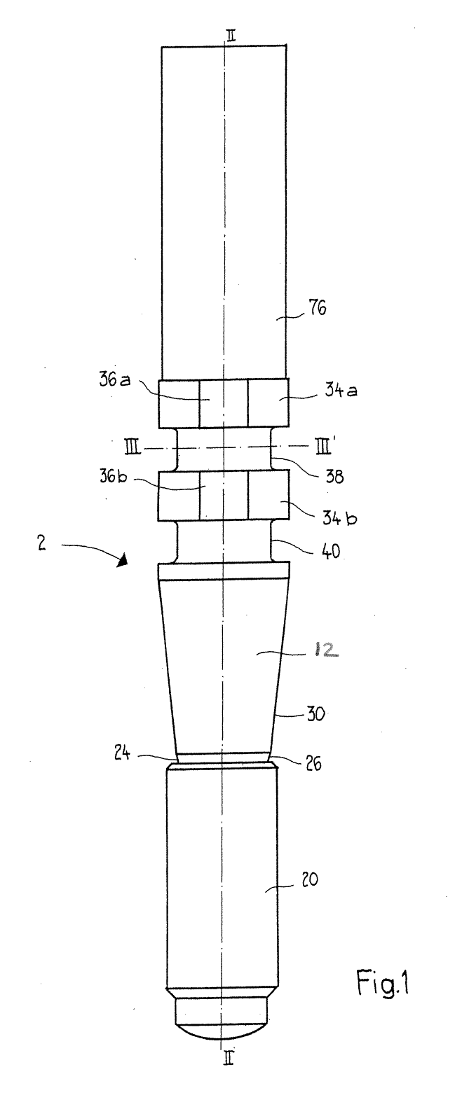

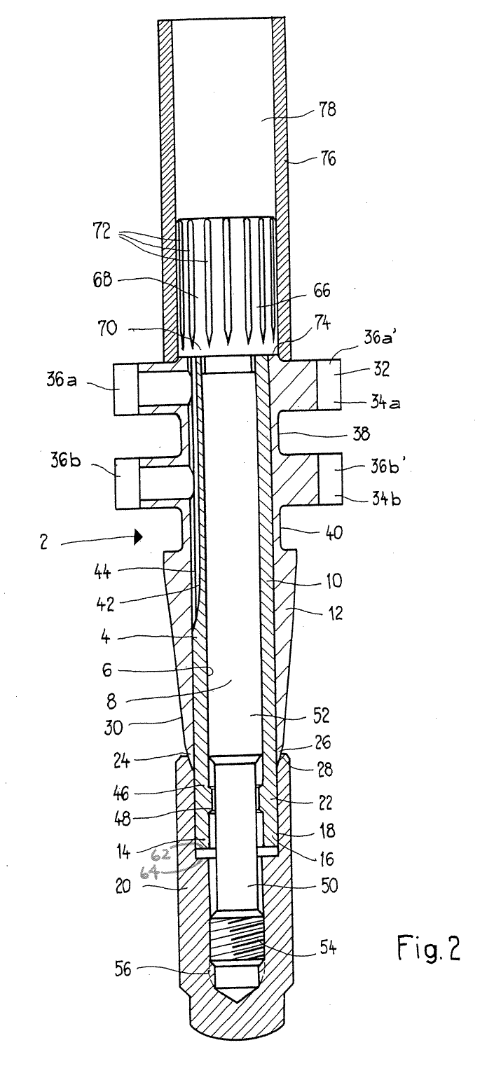

FIG. 1 in conjunction with FIG. 2 shows an impression post 2 according to one embodiment of the invention having a sleeve-shaped impression cap 4 with a substantially cylindrical recess 6 extending in the longitudinal direction and an attachment element 8, in the form of a screw, engaging through the recess 6.

The impression cap 4 has an inner sleeve 10 lying radially on the inside and an outer sleeve arranged coaxially with respect to the inner sleeve and lying radially on the outside; consequently the inner sleeve 10 is arranged between the outer sleeve 12 and the attachment element 8.

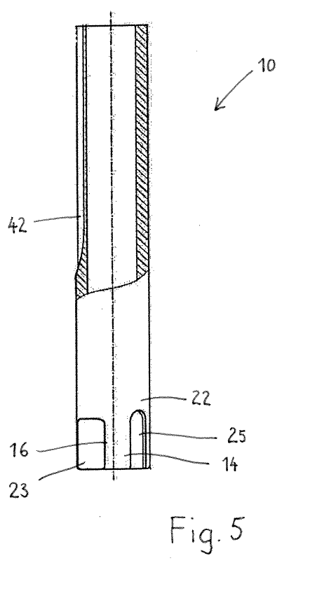

In its apical end region the impression cap 4 has a coupling section 16 which is anchored in a correspondingly shaped opening 18 of the dental implant 20 in an accurately fitting fashion. The inner sleeve 10 is a (hollow) cylinder 22 in the coupling section the shell of which cylinder has at least one flattened region 23 (see FIG. 5) as a stop surface which interacts with a corresponding counter stop surface of the dental implant so as to form a dental implant anti-twist device. In the embodiment of FIG. 5, coupling section 16 also has at least one recess 25 which interacts with a corresponding projection of the dental implant. The coupling section 16 may have two diametrically opposed flattened regions 23 and two diametrically opposed recesses 25.

In its apical end region the outer sleeve 12 and counter stop is in the form of a (hollow) conical frustum 26 in the coupling section 16, which frustum is formed to accurately fit to the corresponding conical section 28 of the opening 18 of the dental implant 20. In the direction facing away from the dental implant 20, the apical end region 24 is adjoined by a likewise conical-frustum-shaped central region The outer surface of the apical end region 24 is slightly tapered inwardly in respect of the central region 30.

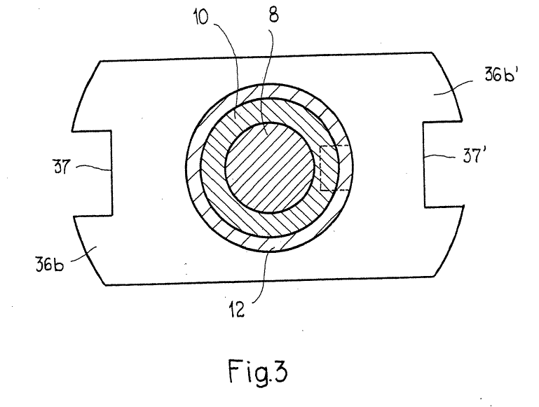

In its occlusal end region 32 lying opposite the apical end region 24, the outer sleeve 12 has two projection sections 34a, 34b with respectively two projections 36a, 36a′ and 36b, 36b′ separated by 180° in the circumferential direction. The projection sections 34a, 34b are separated from one another by an inwardly tapered intermediate segment 38. A further inwardly tapered segment 40 adjoins below, that is to say in the apical direction of the lower projection section 34b, the cross section of which tapered segment 40 basically corresponds to the cross section of the intermediate segment 38 and said tapered segment 40 separates the central region 30 from the projection section 34b. FIG. 3 in particular makes it clear that the projections 36a, 36a′, 36b, 36b′ have recesses 37, 37′ running in the longitudinal direction. The profile designed in this fashion has the purpose of ensuring a deep interlocking connection between the outer sleeve 12 and the impression compound when an impression is being taken.

In its upper, i.e. occlusal, half, the inner sleeve 10 has a groove 42 which runs in the longitudinal direction and which, together with a rail 44 of the outer sleeve 12 guided therein, ensures anti-twist protection between the inner sleeve 10 and the outer sleeve 12. As a result of only a single groove 42 and only a single rail 44 being formed, the position of the inner sleeve 10 in respect of the outer sleeve 12 is unambiguously prescribed in the circumferential direction.

On the inner wall side, the inner sleeve 10 additionally has a circumferential protrusion 48 in its apical end region 46, which protrusion decreases the internal diameter of the recess 6. A first bolt section 50 of the attachment element 8 engages through this region of the recess 6, with a second bolt section 52 having a larger diameter than the first bolt section 50 adjoining said first bolt section in the occlusal direction. In the apical direction, a male thread section 54 on attachment element 8 adjoins the first bolt section 50, which male thread section 54 engages a corresponding female thread section 56 in the opening 18 of the dental implant 20. In the embodiment illustrated in the figures, the diameter of the male thread section 54 basically corresponds to the diameter of the second bolt section 52.

In its occlusal, i.e. facing away from the dental implant 20, end region 66 which protrudes out of the impression cap 4, the attachment element 8 has a head part 68 which is designed as a circular cylinder 70 with channel-shaped recesses 72 running in the longitudinal direction. The end face 74 of the head part 68 facing the impression cap 4 forms a stop surface for the outer sleeve 12, as a result of which the displacement thereof in the direction facing away from the dental implant 20 is restricted. A substantially hollow-cylindrical extension element 76 is placed onto the head part 68 of the attachment element 8, the internal diameter of which extension element basically corresponds to the outer diameter of the head part 68. While the impression is being taken, the extension element 76 prevents the impression compound from covering the head part 68.

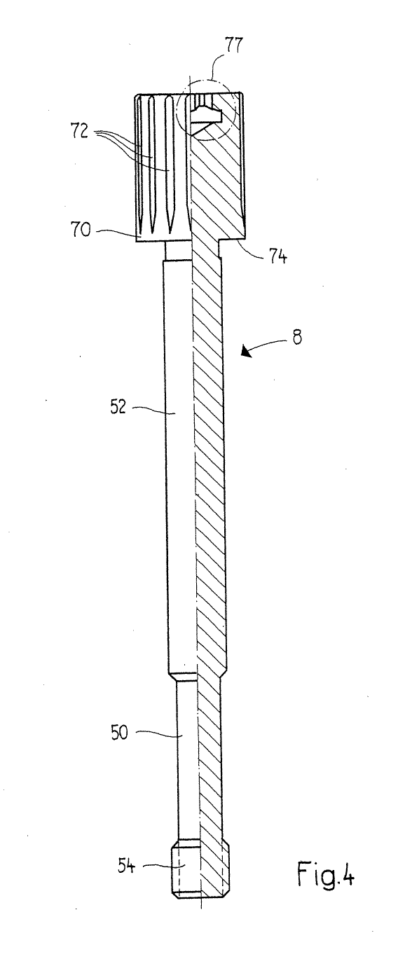

FIG. 4 in particular shows that the head part 68 of the attachment element 8 has a notch 77 for a screwdriver at its occlusal free end.

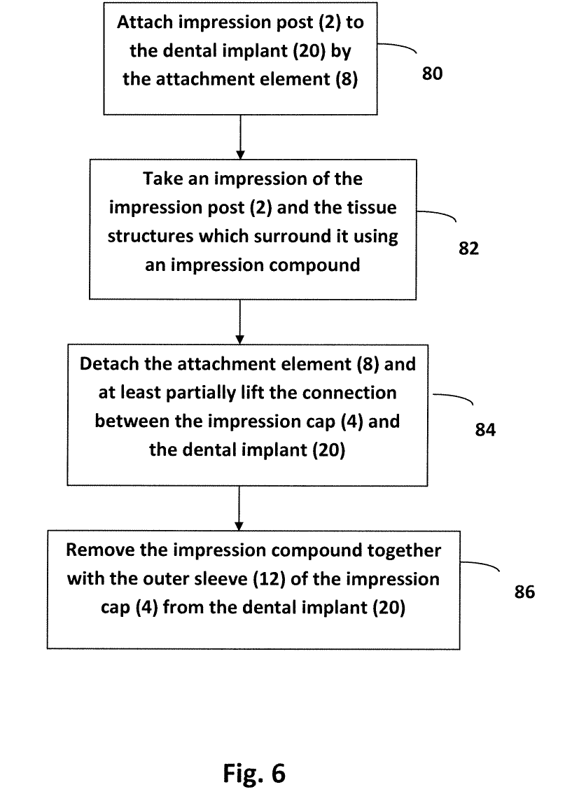

When using the described impression post 2 (see method steps 80, 82, 84 and 86 of FIG. 6), the latter is anchored in the dental implant 20 of which an impression should be taken, with the coupling section 16 being inserted into the opening 18 of the dental implant 20 and being attached using the attachment element 8 (step 80). If the impression cap 4 was not initially inserted up against the stop in the opening 18, it is pushed further into the opening 18 during the attachment by means of the head part 68 of the attachment element 8 until the stop surface 62 of the inner sleeve 10 rests against the counter stop surface 64 of the dental implant 20. In the process, the outer sleeve 12 is held immovably in position by the clamping effect between the dental implant 20 and head part 68. The attachment element 8 is generally tightened by hand, which is facilitated by the radially increased grip of the head part 68. However, the tightening can alternatively also be effected by a tool suitable for the corresponding purposes, such as a screwdriver.

The extension element 76 is placed onto the head part 68 before the impression is taken so the latter is not covered by the impression compound which is subsequently applied around the impression post 2 (step 82).

Once the impression compound has cured, the attachment element 8 is generally detached by a screwdriver (step 84), with the accessibility of the head part 68 of the attachment element 8 being ensured by the channel 78 within the cylindrical extension element 76.

The attachment element 8, when detached from the female thread section 56 in the opening 18 of the dental implant 20, can finally be displaced in the axial occlusal direction out of the outer sleeve 12 embedded in the impression compound, the attachment element 8 taking along with it the inner sleeve 10, with the male thread section 54 acting as a catch element and the protrusion 48 on the inner wall side of the inner sleeve 10 acting as a catch counter element.

Finally, the impression compound with the outer sleeve 12 embedded therein is removed from the dental implant 20 (step 86). As a result of the small contact surface, the static friction between the end region 24 of the outer sleeve 12, designed in a conical frustum shape, and the corresponding conical region 28 of the opening of the dental implant 20 is small even if the displacement is performed obliquely in respect of the longitudinal direction of the outer sleeve 12.

1. An impression post for a dental implant, comprising
a sleeve-shaped impression cap with a coupling section configured to be connected to the dental implant, and a recess extending in a longitudinal direction of the impression cap and
an attachment element engaging through the recess for attaching the impression cap on the dental implant,
wherein the impression cap comprises an inner sleeve and an outer sleeve radially surrounding said inner sleeve on the outside, which outer sleeve is detachably connected to the inner sleeve, and the coupling section is at least partly an element of the inner sleeve.

2. The impression post as claimed in claim 1, wherein the coupling section has a dental implant anti-twist device for anti-twist protection between the impression cap and the dental implant.

3. The impression post as claimed in claim 2, wherein the dental implant anti-twist device is completely an element of the inner sleeve.

4. The impression post as claimed in claim 3, wherein the inner sleeve has an outer sleeve anti-twist device for anti-twist protection between the inner sleeve and the outer sleeve.

5. The impression post as claimed claim 1, wherein the inner sleeve and the outer sleeve are arranged in a predetermined position with respect to one another in a circumferential direction.

6. The impression post as claimed in claim 1, wherein the inner sleeve and the outer sleeve are arranged coaxially with respect to one another.

7. The impression post as claimed in claim 1, wherein the coupling section is shaped so as to be held in a correspondingly shaped opening of the dental implant in an accurately fitting fashion.

8. The impression post as claimed in claim 7, wherein the coupling section of the inner sleeve is designed in the shape of a polygonal cylinder or a pyramid frustum.

9. The impression post as claimed in claim 7, wherein the coupling section comprises a portion of the outer sleeve designed in the shape of a circular cylinder or a conical frustum.

10. The impression post as claimed in claim 1, wherein the outer sleeve has a profile on its outer surface.

11. The impression post as claimed in claim 1, wherein the attachment element is a screw.

12. The impression post as claimed in claim 1, wherein the attachment element has a catch element configured to interact with a corresponding catch counter element on the inner sleeve such that, when the attachment element is displaced in a direction facing away from the coupling section, the inner sleeve is carried along.

13. The impression post as claimed in claim 1, wherein the attachment element is connected to the inner sleeve in an interlocking fashion.

14. The impression post as claimed in claim 1, wherein the attachment element has a head part with a stop surface in its end region facing away from the dental implant while assembled to the implant, which stop surface is configured to interact with an end-face counter stop surface of the inner sleeve and the outer sleeve such that the inner sleeve and the outer sleeve can be connected to the dental implant in a displacement-protected fashion.

15. The impression post as claimed in claim 1, comprising an extension element arranged on the attachment element.

16. The impression post as claimed in claim 15, wherein the extension element is of a hollow cylinder placed onto the attachment element.

17. A method for taking a dental implant impression using an impression post as claimed in claim 1, comprising successive steps of
a) attaching the impression post to the dental implant by the attachment element,
b) taking an impression of the impression post and the tissue structures which surround it by using an impression compound,
c) detaching the attachment element and at least partly lifting the connection between the impression cap and the dental implant and
d) removing the impression compound together with the outer sleeve of the impression cap from the dental implant.

18. A method for taking a dental implant impression using the impression post as claimed in claim 1, comprising taking an open tray impression.
